(19) United States
(12) Patent Application Publication
(10) Pub. No.: US 2012/0091606 A1
(43) Pub. Date: Apr. 19, 2012

(54) METHOD FOR MANUFACTURING FINE POLYMER, AND FINE POLYMER MANUFACTURING APPARATUS

(76) Inventors: Mitsuhiro TAKAHASHI, Ehime (JP); Mikio Takezawa, Kagawa (JP); Yoshiaki Tominaga, Kanagawa (JP); Takahiro Kurokawa, Tokyo (JP); Hiroto Sumida, Nara (JP); Kazunori Ishikawa, Osaka (JP)

(21) Appl. No.: 13/337,609

(22) Filed: Dec. 27, 2011

Related U.S. Application Data
(62) Division of application No. 12/666,165, filed on Dec. 22, 2009.

(30) Foreign Application Priority Data
Jul. 11, 2007 (JP) 2007-182365

(51) Int. Cl. B29B 9/12

(52) U.S. Cl. 264/12; 425/7

(57) ABSTRACT

A method for manufacturing a fine polymer including: generating superheated steam by a superheated steam generating unit (101); adjusting the pressure of the generated superheated steam by a pressure adjusting unit (102); receiving a polymer by a reception unit (103); heating the received polymer to a predetermined temperature by a heating unit (104); discharging the heated polymer through a first discharge port (111); and discharging the superheated steam through a second discharge port (121) at the same time as the time when the heated polymer is discharged. Here, the second discharge port (121) surrounds the first discharge port (111), and the first discharge port (111) and the second discharge port (121) face the same direction.

This is a divisional application of application Ser. No. 12/666,165, which is the National Stage of International Application No. PCT/JP2008/001785, filed Jul. 4, 2008.

### TECHNICAL FIELD

The present invention relates to a method for manufacturing a fine swelled polymer, and a fine polymer manufacturing apparatus, and in particular to a method for manufacturing a fine swelled polymer for manufacturing nanofiber products, and a fine polymer manufacturing apparatus.

### BACKGROUND ART

The electrospinning method is known as a method for manufacturing thread-shaped materials containing a polymer and having a diameter of a submicron scale (hereinafter referred to as “nanofibers.”

The electrospinning method is a method for generating nanofibers by injecting a polymer solution (or letting the polymer solution flow) toward a collector (collecting electrode) through needle-shaped injecting nozzles of an apparatus. The polymer solution contains a solvent and a polymer dispersed in form of particles in the solvent, and the injecting nozzles have been applied with high voltage.

In the electrospinning method, high voltage is applied to the injecting nozzles so that the polymer solution injected in a predetermined space through the injecting nozzles is charged, first. As the solvent vaporizes, the charge density of the polymer solution containing polymer particles flying in the air increases. At the time point when the Coulomb force in the repulsive direction occurring in the polymer solution exceeds the interfacial force of the polymer solution, the polymer particles in the polymer solution are dramatically stretched in line-shape. This phenomenon is called an “electrostatic explosion.” Such electrostatic explosions occur in sequence in the predetermined space, yielding nanofibers containing fine polymer particles having a submicron diameter.

In addition, it is possible to generate a thin film having a three-dimensional net-shaped structure by depositing the nanofibers generated using the above-mentioned method on a substrate, and to manufacture a highly porous web (nonwoven fabric) having a submicron-scale net-shaped structure by depositing the nanofibers on the substrate until the thickness of an in-process nanofiber film becomes greater than the thin film.

The highly porous webs manufactured using the electrospinning method have nano-order holes, and has a large surface as the whole web. Thus, the highly porous webs are applicable to filters, separators in battery cells, polymer electrolytes for fuel cells, electrodes or the like, and are expected to provide high performances.

A conventionally proposed apparatus causes a large number of nanofibers to deposit on a deposition unit by using internal injecting nozzles arranged in parallel with each other and finishes the highly porous webs made of the nanofibers according to a method for generating a large number of nanofibers to manufacture practical highly porous webs made of the nanofibers (As an example, see Patent Citation).

The apparatus applies high voltage equals to or greater than 5 KV between the injecting nozzles and a collector, and either grounds the collector or applies, to the collector, voltage having the polarity opposite to the voltage applied to the injecting nozzles, and generates nanofibers.

### [Patent Citation 1]

### Japanese Unexamined Patent Application Publication No. 2002-201559

### DISCLOSURE OF INVENTION

### Technical Problem

As described above, a raw solution which is used for generating nanofibers is obtained by dissolving (or dispersing) a polymer in form of particles in a solvent. As the solvent, an organic solvent is used in many cases. The organic solvent contained in the raw solution vaporizes in the process of generating nanofibers, and thus sufficient consideration must be given to people and environment in selecting and using the organic solvent. For example, it is necessary to install a nanofiber product manufacturing apparatus in a closed space, or collect the vaporized organic solvent, as a precaution.

In the case where a flammable organic solvent is used, a precaution for preventing an explosion must be taken for the nanofiber product manufacturing apparatus.

For this reason, conventional nanofiber product manufacturing apparatuses are inevitably complicated and upsized, increasing the manufacturing and space costs.

In addition, it is necessary that the weight ratio of the organic solvent with respect to the raw solution is as much as 50 to 95 percent, and thus a large amount of organic solvent is necessary in order to generate nanofibers of a predetermined amount. The cost of the organic solvent is a major cause in the increase in the total cost.

### Technical Solution

The present invention has been made in order to solve the above problem, and aims at providing a method for manufacturing a fine polymer, a fine polymer manufacturing apparatus, a method for manufacturing nanofiber products, a nanofiber product manufacturing apparatus, and the like all of which are safe and inexpensive.

In order to achieve the above-mentioned aim, the method for manufacturing a fine polymer containing fine swelled polymer particles according to the present invention includes: generating superheated steam by a superheated steam generating unit; adjusting the pressure of the generated superheated steam by a pressure adjusting unit; receiving a polymer by a reception unit; heating the received polymer to a predetermined temperature by a heating unit; discharging the heated polymer through a first discharge port; and discharging the superheated steam through a second discharge port at the same time as the time when the heated polymer is discharged. Here, the second discharge port surrounds the first discharge port, and the first discharge port and the second discharge port face the same direction.

According to this method, it becomes possible to make finer the particles of the polymer and swell the polymer in a solvent such as water, collect the fine swelled particles of the fine polymer, and manufactures a fine polymer having a low viscosity.

Further, the method for manufacturing the fine polymer may include re-supplying, to the reception unit, the fine polymer discharged when the fine polymer is discharged.

With this structure, it becomes possible to make finer the particles of the polymer and swell the particles of the polymer in the solvent such as water several times so that the fine polymer becomes homogenized.

When the above-mentioned polymer is used in the generation of the nanofibers, it is possible to generate the nanofibers safely and inexpensively.

In order to achieve the above-mentioned aim, the fine polymer manufacturing apparatus according to the present invention includes: a superheated steam generating unit configured to generate superheated steam; a pressure adjusting unit configured to adjust the pressure of the generated superheated steam; a reception unit for receiving a polymer; a heating unit configured to heat the received polymer to a predetermined temperature; a first discharge port through which the heated polymer is discharged; and a second discharge port through which the superheated steam is discharged. Here, the second discharge port surrounds the first discharge port, and the first discharge port and the second discharge port face the same direction.

As describe above, the fluid which is discharged through one of these two discharge ports is the superheated steam, which makes it possible to heat and make finer the particles of the polymer and swell the particles of the polymer by mixing water molecules between the polymer molecules in the particles of the polymer.

In addition, the present invention may be implemented as a nanofiber product manufacturing apparatus including: a reception unit for receiving a polymer; a heating unit configured to heat the polymer to a predetermined temperature; a first discharge port through which the heated polymer is discharged; and a second discharge port through which a fluid containing water is discharged, the second discharge port surrounding the first discharge port, and the first discharge port and the second discharge port facing the same direction, a charge applying electrode which applies electric charge to the heated polymer when the heated polymer is discharged; a collecting electrode which collects nanofibers injected through the injecting hole; and a power source for generating an electric field between the charge applying electrode and the collecting electrode.

With this structure, it becomes possible to generate a fine polymer containing fine swelled polymer particles, and generate nanofibers by causing a sequence of electrostatic explosions safely and easily.

### Advantageous Effects

With the present invention, it becomes possible to easily provide a fine polymer containing fine swelled polymer particles as a raw material for generating nanofibers. Furthermore, when the fine polymer is used in the generation of the nanofibers, it becomes possible to generate the nanofibers safely and inexpensively.

[Further Information about Technical Background to this Application]

The disclosure of Japanese Patent Application No. 2007-182365 filed on Jul. 11, 2007 including specification, drawings and claims is incorporated herein by reference in its entirety.

### BRIEF DESCRIPTION OF DRAWINGS

These and other objects, advantages and features of the invention will become apparent from the following description thereof taken in conjunction with the accompanying drawings that illustrate a specific embodiment of the invention.

FIG. 1 is a cross-sectional view of a fine polymer manufacturing apparatus according to the present invention.

FIG. 2 is a conceptual diagram showing enlarged particles of a polymer.

FIG. 3 is a conceptual perspective view of a nonwoven fabric manufacturing apparatus including a nanofiber product manufacturing apparatus.

FIG. 4 is a diagram showing an example of an injecting unit and a collecting electrode.

FIG. 5 is a perspective view of a variation of the nonwoven fabric manufacturing apparatus.

FIG. 6 is a cross-sectional view of a variation of the fine polymer manufacturing apparatus.

FIG. 7 is a cross-sectional view of a fine polymer manufacturing apparatus and a nanofiber product manufacturing apparatus integrated with each other.

### EXPLANATION OF REFERENCE

100 fine polymer manufacturing apparatus
101 superheated steam generating device
102 pressure adjusting device
103 reception tank
104 heater
105 power source
106 pump
107 storage tank
108 control device
109 thermometer
110 inside nozzle
111 first discharge port
112 conveying path
120 outside nozzle
121 second discharge port
122 entrance hole
130 two-axis extruder
131 hopper
132 re-conveying path
136 re-supply pump
200 nanofiber product manufacturing apparatus
210 injecting unit
211 pipe
212 injecting hole
213 nozzle
214 pulley
215 belt
216 rotary cylinder
217 shaft
218 motor
219 base
220 collecting electrode
250 first power source
251 second power source
300 nonwoven fabric manufacturing apparatus
360 sheet
370 conveying unit
400 nanofiber
400 polymer
410 nonwoven fabric

### BEST MODE FOR CARRYING OUT THE INVENTION

### Embodiment

The following describes a fine polymer manufacturing apparatus 100 according to the present invention.

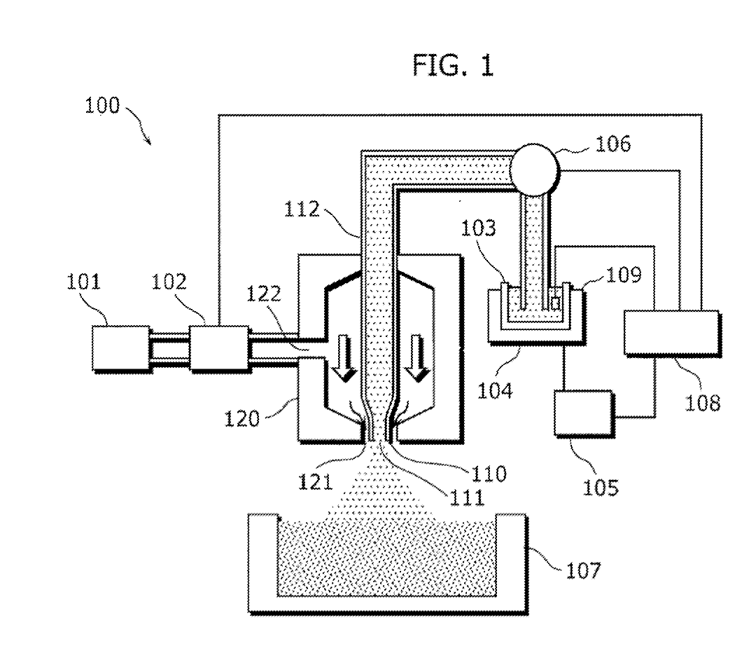

FIG. 1 is a cross-sectional view of the fine polymer manufacturing apparatus 100 according to the present invention.

As shown in FIG. 1, the fine polymer manufacturing apparatus 100 includes: a superheated steam generating device 101 as a superheated steam generating unit, a pressure adjusting device 102 as a pressure adjusting unit, a reception tank 103 as a reception unit, a heater 104 which constitutes a heating unit, a power source 105 which constitutes the heating unit, an inside nozzle 110 having a first discharge port 111, an outside nozzle 120 having a second discharge port 121, a pump 106, a storage tank 107, and a control unit 108.

The superheated steam generating device 101 includes a boiler which is a saturated steam generating device for generating saturated steam, and is capable of heating the saturated steam generated in the boiler to 100 degrees Celsius or more in a normal pressure, and is capable of generating normal-pressure superheated steam. In this embodiment, it is assumed that the temperature of the superheated steam to be supplied can be set at an arbitrary temperature within 500 degrees Celsius.

Here, superheated steam means steam having a temperature exceeding 100 degrees Celsius. In this embodiment, the term “superheated steam” means steam in phase of H₂O gas.

Methods for heating saturated steam to generate superheated steam include a method for heating saturated steam with an electric heater and a method for heating saturated steam by burning fuel. The method employed in this embodiment is a method for generating superheated steam by bundling several metal pipes, heating the metal pipes using eddy current heating, and causing the saturated steam to pass through each of the metal pipes. The power source which is used to heat the metal pipes is a high frequency power source (supplying a frequency of 10 KHz to 60 KHz inclusive).

The pressure adjusting device 102 as the pressure adjusting unit is a device which increases the pressure of the superheated steam with a normal pressure generated by the superheated steam generating device 101 to a predetermined pressure. The superheated steam having the predetermined pressure which is discharged through the second discharge port 121 can make finer the particles of the polymer and swell, in the superheated steam, the particles of the polymer which is discharged through the first discharge port 111.

The reception tank 103 corresponds to the reception unit into which the polymer is fed, and in which the polymer is stored.

The heater 104 as the heating unit is an electric heater surrounding the reception tank 103, heats the polymer stored in the reception tank 103 until the viscosity of the polymer is decreased enough to be discharged through the first discharge port 111.

The power source 105 as the heating unit is a device which supplies electricity to the heater 104. The electricity to be supplied can be arbitrarily adjusted.

The first discharge port 111 is an opening part through which the polymer having the temperature increased by the heated steam and having the decreased viscosity is discharged. The first discharge port 111 is at the edge of the inside nozzle 110 which is the edge portion of the conveying path 112 through which the polymer is conveyed. The diameter of the conveying path 112 becomes smaller toward the edge portion of the inside nozzle 110.

The second discharge port 121 is an opening part through which superheated steam having a pressure increased by the pressure adjusting device 102 is discharged, and has a shape of a circle surrounding the first discharge port 111. The outside nozzle 120 includes the second discharge port 121 at the edge, has a shape of a cylinder placed concentrically with respect to the inside nozzle 110. The opposite edge of the second discharge port 121 is in close contact with the periphery of the conveying path 112 and thus is closed. The outside nozzle 120 includes an entrance hole 122 through which superheated steam having the increased pressure enters. The entrance hole 122 is integrated with a portion of the peripheral wall of the outside nozzle 120.

The pump 106 is a pump for pumping, to the first discharge port 111, the polymer in the reception tank 103 heated by the heater 104 until the viscosity of the polymer is decreased to a predetermined value.

The storage tank 107 receives the polymer containing fine swelled polymer particles, and stores the polymer together with water.

The control device 108 is a computer for controlling the pressure adjusting device 102, the power source 105, the pump 106, and the like. The control device 108 analyzes data obtained from a thermometer 109 and the like, and adjusts the temperature and pressure of the polymer to predetermined values by performing feedback control of the following: the pressure of superheated steam which is increased by the pressure adjusting device 102, the electricity that the power source 105 applies to the heater 104, the pressure of the polymer which is pumped by the pump 106, and the like.

The following describe the method for manufacturing the fine polymer and the fine polymer manufacturing apparatus 100.

First, a desired polymer is fed into the reception tank 103. The polymer may have any form such as a pellet form. There is no need to limit, to only one, the number of polymers used for the polymer to be fed, several kinds of polymers may be used.

The temperature of the polymer fed into the reception tank 103 is increased to the predetermined temperature by the heater 104. The temperature of the polymer is always being checked with the thermometer 109. The control device 108 monitors the temperature variation and controls the amount of electricity being supplied from the power source 105 so that the temperature of the polymer is kept at the predetermined temperature.

Next, when the control device 108 judges that the temperature of the polymer reaches the predetermined temperature, the control device 108 operates the pump 106, and controls the pump 106 to pump the polymer with the predetermined pressure. In this way, the polymer is pumped to the first discharge port 111.

As described above, the polymer is discharged with the predetermined pressure through the first discharge port 111.

On the other hand, the superheated steam generating unit 101 generates superheated steam having a predetermined temperature. The pressure adjusting device 102 is controlled by the control device 108 to increase the pressure of the superheated steam generated by the superheated steam generating device 101 to the predetermined pressure.

The superheated steam having the predetermined pressure is supplied to the outside nozzle 120 and discharged through the second discharge port 121 surrounding the first discharge port 111.

The polymer is discharged through the first discharge port 111 at the same time as the time when the superheated steam is discharged through the second discharge port 121. The gas-liquid mixed spray nozzle provides an effect that the polymer having micro particles is injected.

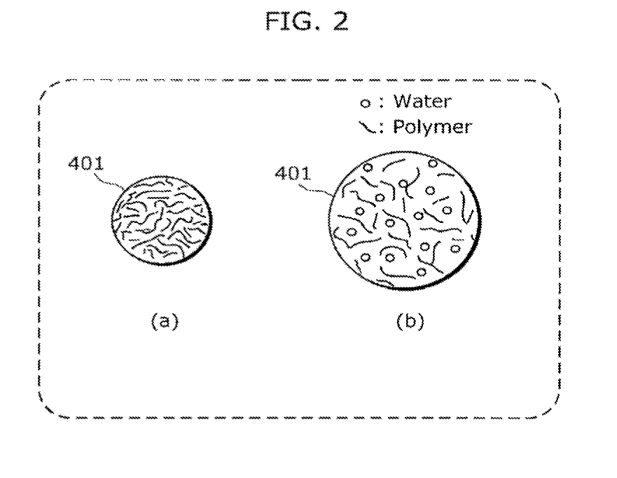

The superheated steam has a high radiation heating effect in addition to a convection heating effect, and has functions of heating the polymer to be discharged from the first discharge port 111 and decreasing the viscosity of the polymer. The polymer is mixed with the heated steam when the polymer and the heated steam are discharged at the same time. The polymer mixed with the heated steam is heated until the particles of the polymer are made finer to the degree by which the molecules in the particles of the polymer are not damaged. As shown in FIG. 2(b), water molecules are mixed between the fine polymer molecules in a polymer particle 401 of the polymer. It should be noted that FIG. 2(a) shows a polymer particle 401 containing the polymer molecules but not containing water molecules mixed between the polymer molecules.

The above-mentioned gas-liquid mixed spray nozzle and the superheated steam provide effects of making finer the polymer particles 401 of the polymer to 5 to 100 micron, and swelling the polymer particles 401 in the solvent such as water. It is possible to change the size of the polymer particles 401 to an arbitrary size such as 30 micron and 50 micron by adjusting one or some of the following: the temperature and pressure of the superheated steam, and the temperature (viscosity) and pressure of the polymer.

Lastly, the fine polymer containing fine swelled polymer particles is collected together with the superheated steam, and the polymer mixed with the superheated steam are stored in the storage tank 107.

The polymer molecules of the stored polymer are dispersed in water as if the polymer were emulsified (or quasi-emulsified).

The above-described apparatuses and methods make it possible to manufacture the fine polymer containing fine swelled polymer particles and having a low viscosity, without using any organic solvent. Furthermore, the fine polymer particles 401 are easy to separate because water molecules mix between the fine polymer molecules, and the intermolecular force of the polymer molecules in the polymer particles 401 of the polymer weakens.

There is another method for making finer the polymer particles 401 of the polymer using ultrasonic vibration, but this method entails a problem that the ultrasonic vibration separates the polymer molecules into low-molecular molecules having different properties as a material. In contrast, the above-described apparatuses and methods make it possible to provide the polymer having a low viscosity and desired properties as a polymer without using any organic solvent because the polymer molecules of the fed polymer are maintained intact.

Examples of polymers which may be used as the polymer are as follows: polypropylene, polyethylene, polystyrene, polyethylene oxides, polyethylene terephthalate, polybutylene terephthalate, polyethylene naphthalate, poly-m-phenylene terephthalate, poly-p-phenylene isophthalate, polyvinylidene difluorides, a polyvinylidene difluoride-hexafluoro propylene copolymer, polyvinyl chlorides, a polyvinylidene chloride-acrylate copolymer, polyacrylonitrile, a polyacrylonitrile-methacrylate copolymer, poly-carbonates, polyallylate, polyester carbonates, nylon, aramid, polycaprolactone, polylactric acid, polyglycolic acid, collagen, polyhydroxybutyric acid, polyvinyl acetates, and polypeptides. In addition, it is also possible to provide a composition of polymers obtained by arbitrarily selecting and feeding several kinds of polymers from among the listed polymers.

The following describe a method for manufacturing nanofiber products made from the fine polymer containing fine swelled polymer particles manufactured using the above apparatuses, a nanofiber product manufacturing apparatus, a method for manufacturing nonwoven fabrics by depositing the generated nanofibers, and a nonwoven fabric manufacturing apparatus.

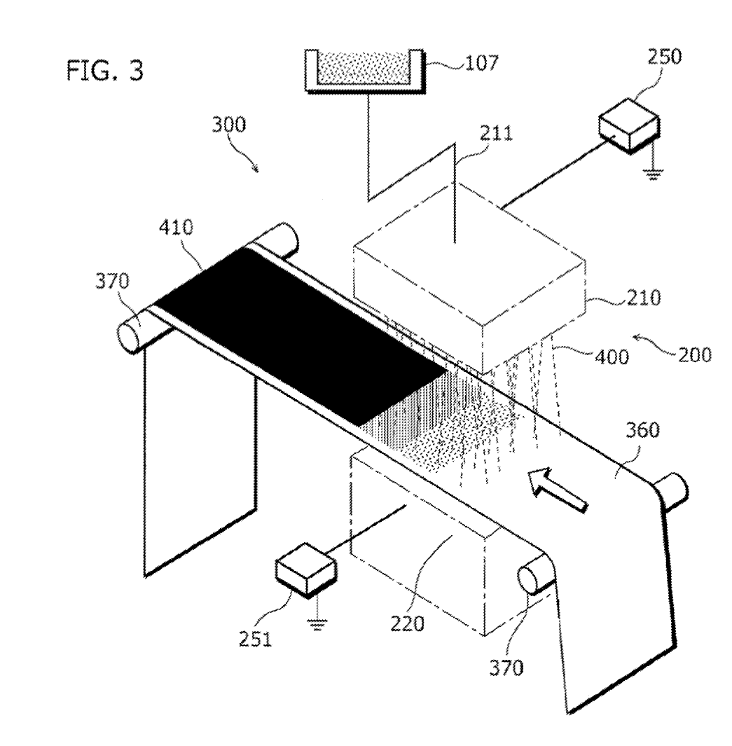

FIG. 3 is a conceptual perspective view of the nonwoven fabric manufacturing apparatus 300 including the nanofiber product manufacturing apparatus.

As shown in FIG. 3, the nonwoven fabric manufacturing apparatus 300 includes: a nanofiber product manufacturing apparatus 200 including an injecting unit 210 and a collecting electrode 220, and a deposition sheet 360 as a deposition unit. It should be noted that numerical reference 400 is assigned to both the polymer to be injected and an in-process nanofiber film because they cannot be clearly distinguished from each other, and numerical reference 410 is assigned to a finished nonwoven fabric.

The injecting unit 210 is a device having injecting holes for injecting a polymer (or letting the polymer flow) for generating nanofibers. A first power source 250 applies potential predetermined with respect to a ground potential to the injecting unit 210.

The injecting unit 210 is connected to a storage tank 107 for storing the polymer and a pipe 211 through which the fine polymer containing fine swelled polymer particles is supplied with a predetermined pressure.

The collecting electrode 220 is a device which is connected to the second power source 251 so that the predetermined voltage is applied to the injecting unit 210, and collects the generated nanofibers 400.

It should be noted that the first power source 250 and the second power source 251 have the function of directly grounding the injecting unit 210. It is only necessary that the nanofiber product manufacturing apparatus 200 generates an electric field (electric line of force) between the injecting unit 210 and the collecting electrode 220. The nanofiber product manufacturing apparatus 200 may induce charge to the injecting unit 210 and the collecting electrode 220 by applying potential to a third electrode in addition to applying charge directly from the first power source 250 and the second power source 251, and may thereby generate an electric field.

In addition, an inorganic solid material may be mixed in the polymer. The inorganic solid material functions, for example, as an aggregate for nanofibers to be generated and as a solvent carried by the nanofibers. Examples of the inorganic solid materials include: oxides, carbides, nitrides, borides, silicides, fluorides, and hydrosulfides. It is desirable that an oxide is used in terms of heat resistance and processability.

Examples of oxides include: Al₂O₃, SiO₂, TiO₂, Li₂O, Na₂O, MgO, CaO, SrO, BaO, B₂O₃, P₂O₅, SnO₂, ZrO₂, K₂O, Cs₂O, ZnO, Sb₂O₃, As₂O₃, CeO₂, V₂O₅, Cr₂O₃, MnO, Fe₂O₃, CoO, NiO, Y₂O₃, Lu₂O₃, Yb₂O₃, HfO₂, and Nb₂O₅. At least one of these can be used, but candidates are not limited to these.

The deposition sheet 360 is a component on which nanofibers 400 generated in the predetermined space are deposited, and a flexible thin continuous sheet from which a nanofiber film made of the deposited nanofibers can be easily separated. The deposition sheet 360 is rolled and supplied in the roll form. A conveying unit 370 conveys the portion, of the deposition sheet 360, on which the nanofibers are deposited in the direction shown by an arrow in FIG. 3. The sheet 360 is re-rolled together with a nonwoven fabric 410 generated on the deposition sheet 360.

The conveying unit 370 is a device capable of conveying the deposition sheet 360 in one direction maintaining a predetermined tension by causing rollers shown in FIG. 3 to rotate by using a motor (not shown).

It should be noted that the injecting unit 210 and the collecting electrode 220 have various variations, and there are various combinations of these. In FIG. 3, the injecting unit 210 and the collecting electrode 220 are shown symbolically by alternate long and short dash lines, and specific variations of the injecting unit 210 and the collecting electrode 220 are described in detail below.

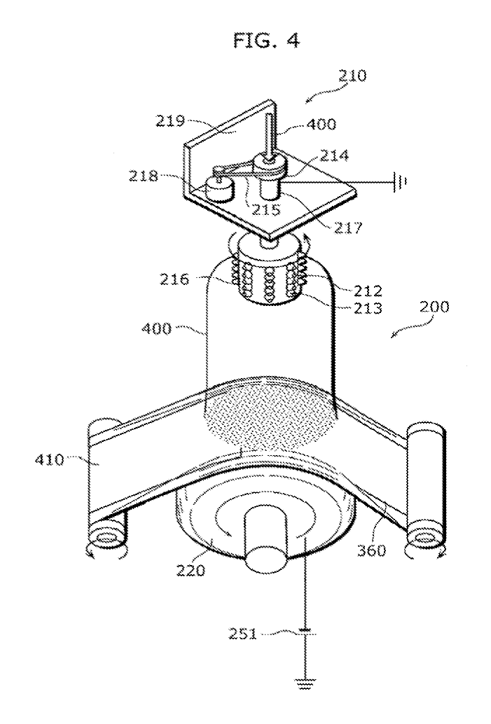

FIG. 4 is a diagram showing examples of the injecting unit 210 and collecting electrode 220.

It should be noted that the injecting unit 210 is magnified in FIG. 4 to clarify the relationship between the injecting unit 210 and the collecting electrode 220. In practice, the diameter of the rotary cylinder 216 is approximately several centimeters to several tens of centimeters, while the diameter of the collecting electrode 220 is several meters.

The collecting electrode 220 is cylinder-shaped, and can rotate in synchronization with the movement of the deposition sheet 360. The collecting electrode 220 has a cylinder-shaped edge part on which round chamfering has been performed, so that the diameter of the collecting electrode 220 is gradually reduced toward the edge.

The surface of the peripheral part of the collecting electrode 220 is curved against the injecting unit 210 in order to prevent the electric field from being interfered by the edge. This makes it possible to yield an excellent deposition of nanofibers 400.

As shown in FIG. 4, the injecting unit 210 is a device which injects the polymer (or lets the polymer flow) using centrifugal force. The injecting unit 210 includes: a rotary cylinder 216, a shaft 217 which is a rotation axis and functions as a pipe 211 for supplying the polymer 400, a motor 218, a base 219, a belt 215, and a pulley 214.

The rotary cylinder 216 includes injecting nozzles 213 arranged in a radiated manner. These injecting nozzles 213 include injecting holes 212 on the peripheral wall of the rotary cylinder 216 having a closed end. The rotary cylinder 216 has the other end at the center of which a shaft 217 is attached. The rotary cylinder 216 is connected to the base 219 through the shaft 217 so that it can rotate.

The motor 218 and the pulley 214 fixed on the shaft 217 are connected using a belt 215, and the motor 218 is attached to the base 219. In this structure, a rotation of the motor 218 rotates the rotary cylinder 216 with respect to the base 219.

The shaft 217 is connected to the other edge of the rotary cylinder 216 so that a fluid can pass through inside the shaft 217 and the rotary cylinder 216. Both of the shaft 217 and the rotary cylinder 216 are made of conductors. The shaft 217 is connected to the first power source 250 through a brush. The brush makes it possible to maintain the predetermined potential even while the rotary cylinder 216 is rotating.

The rotary cylinder 216 is connected, through the shaft 217, to the storage tank 107 in which the polymer 400 is stored. A pump is attached on a path through which the polymer 400 is fed, and the pump pumps the polymer 400 toward the rotary cylinder 216.

The following describe a method for manufacturing nanofiber products made of nanofibers 400 for use with the nanofiber product manufacturing apparatus 200 including an injecting unit 210 and a collecting electrode 220, and a method for manufacturing nonwoven fabrics by depositing the manufactured nanofibers 400.

First, the polymer 400 is pumped up from the storage tank 107 toward the rotary cylinder 216. In this embodiment, the pumping pressure is relatively low because the polymer 400 is injected without using a pumping pressure.

The polymer 400 is injected inside the rotary cylinder 216 through the shaft 217 (pipe 211). The rotary cylinder 216 is rotated by the motor 218, and the rotation produces centrifugal force in the injected polymer 400. By the centrifugal force, the polymer 400 is injected in a radiated manner to outside the rotary cylinder 216 through the injection holes 212 pierced in the peripheral wall of the rotary cylinder 216.

Since the polymer 400 is injected through the injection holes 212 in the rotating rotary cylinder 216, the polymer 400 is injected through the injecting holes 212 evenly on the whole surface within the space even when the shapes of the injecting holes 212 are different in some degree. The use of the injecting unit 210 as described above makes it possible to manufacture a comparatively large amount of nanofibers 400 having the same quality at a time. This makes it possible to manufacture nonwoven fabrics 410 in which the nanofibers are evenly dispersed.

The second power source 251 applies, to the collecting electrode 220, voltage determined within one of the following ranges: from plus 10 KV to plus 200 KV inclusive, and from minus 10 KV to minus 200 KV inclusive. Induced charge according to the voltage of the collecting electrode 220 is generated in the rotary cylinder 216 which is grounded, and an electric field (electric line of force) is generated between the rotary cylinder 216 and the collecting electrode 220.

In the state, the polymer 400 is injected from the rotary cylinder 216. Charge necessary to cause a sequence of electrostatic explosions is applied to the polymer 400. The particles of the polymer 400 fly along the electric field (electric line of force), and cause a sequence of electrostatic explosions, yielding nanofibers 400.

Here, the polymer 400 contains swelled high polymer particles in which water molecules are present between the polymer molecules. Therefore, the polymer 400 containing swelled high polymer particles has a volume greater than the volume of the polymer not containing any swelled polymer particles. The polymer 400 containing swelled polymer particles can hold a larger amount of charge compared with the polymer not containing such swelled polymer particles. The applied charge penetrates deep inside the polymer particles of the polymer 400 as water vaporizes, and cases a sequence of electrostatic explosions by which combined polymer molecules are separated from each other. Accordingly, the use of the polymer 400 prepared using the method makes it possible to generate nanofibers without using any organic solvent.

The generated nanofibers 400 are deposited on the deposition sheet 360, and the deposition sheet 360 is gradually rolled, producing a continuous nonwoven fabric on the deposition sheet 360.

In this embodiment, it is determined that the injecting unit 210 has a ground potential, but arbitrary output voltage such as voltage ranging from minus 1 KV to plus 1 KV may be applied to the injecting unit 210.

FIG. 4 shows a single injecting unit 210, but in the case of using a wide deposition sheet 360 or increasing the thickness of a nanofiber film, it is effective to use several injecting units 210 arranged in some manner.

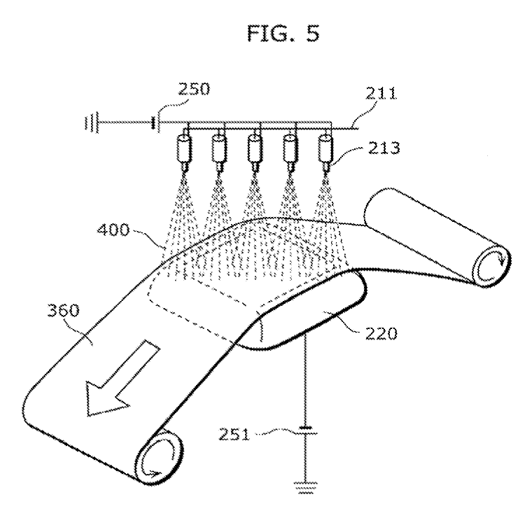

It should be noted that the structure of the injecting unit 210 is not limited to the structure described in this embodiment. For example, as shown in FIG. 5, the injecting nozzles 213 may be fixed with respect to the collecting electrode 220. In this case, by arranging several injecting nozzles 213 diagonally with respect to the direction of movement of the deposition sheet 360, it becomes possible to widen the interval of the respective injecting nozzles 213 and evenly deposit the nanofibers 400 on the deposition sheet 360.

The following describes a variation of the fine polymer manufacturing apparatus.

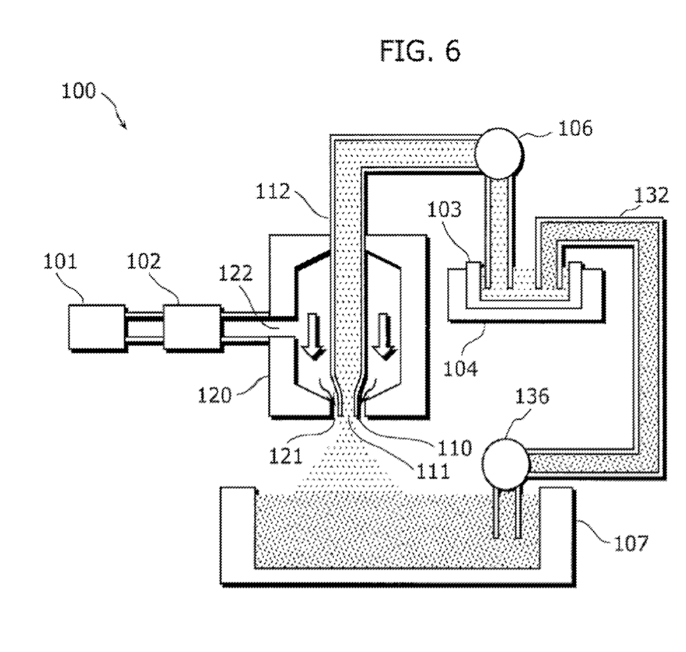

A fine polymer manufacturing apparatus 100 shown in FIG. 6 includes: a re-supply pump 136 for re-supplying the polymer stored in the storage tank 107 to the reception tank 103; and a re-conveying path 132.

With this structure, it is possible to re-homogenize the polymer precipitated and agglomerated, and further make finer and swell, in the solvent, the particles of the polymer.

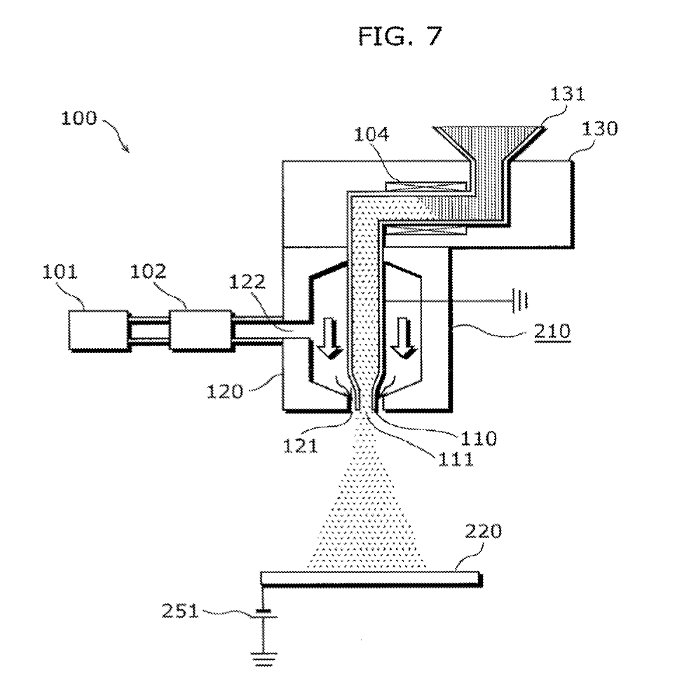

In addition, as shown in FIG. 7, the following processes may be performed: feeding, to a hopper 131, a polymer and an inorganic material in form of a pellet; kneading the polymer and the inorganic material using a kneader such as two-axis extruder 130 or the like while heating the polymer and the inorganic material using the heater 104, and discharging the polymer through the first discharge port 111.

Further, the inside nozzle 110 and the outside nozzle 120 may be grounded and used as the injecting unit 210. In this case, the particles of the polymer are made finer and swelled in the superheated steam and fly from the gas-liquid mixed spray nozzle, and the inside nozzle 110 and the outside nozzle 120 connected to the earth function as charge applying electrodes for applying charge to the polymer to be discharged through the inside nozzle 110 and the outside nozzle 120. The particles of the polymer fly in the electric field generated between the collecting electrode 220 with high voltage and each of the inside nozzle 110 and the outside nozzle 120, causing a sequence of electrostatic explosions.

With this structure, it becomes possible to perform the sequence of processes starting with feeding of the polymer and ending with the generating of the nanofiber products.

No organic solvent is used in this embodiment, but it should be noted that the present invention does not completely exclude the use of an organic solvent. A proper amount of organic solvent may be used for adjusting the viscosity of the polymer or for other purposes as necessary.

The present invention discloses emulsifying or quasi-emulsifying the polymer using water as a solvent and superheated steam, but the materials contained in the raw solution for generating nanofibers are not limited to these. For example, a raw solution may be emulsified or quasi-emulsified by using a gas-liquid mixed spray nozzle only without using superheated steam, depending on the kind of polymer. Here is a specific example. How well polymers such as poly vinyl alcohol (PVA) are dissolved in water vary depending on the saponification degrees. Thus, depending on the saponification degree of the polymer to be used, it is possible to manufacture a raw solution in which poly vinyl alcohol (PVA) is emulsified or quasi-emulsified by using an apparatus structured as shown in FIG. 1 but without using superheated steam.

Methods for emulsifying water-soluble polymers for generating nanofibers are not limited to this. A method using a mixer, a colloid mill, a homogenizer, or the like may be used for manufacturing an emulsified polymer or a quasi-emulsified polymer so as to generate nanofibers from the manufactured polymer.

It should be noted that there is no clear boundary between an “emulsified” polymer and a “quasi-emulsified” polymer. For example, when the particles of a polymer are emulsified for a predetermined period of time, but subsequently the particles precipitate or dissolve as time elapses, this polymer may be described as a “quasi-emulsified” polymer.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### EXAMPLES

The following describe examples according to the present invention in comparison with conventional examples.

### Experiment 1

### Using a Conventional Method

First, a raw solution for generating nanofibers was generated using the following method. Poly vinyl alcohol (PVA) and water (tap water) were prepared as a polymer and as a solvent, respectively.

A mixed liquid was generated by feeding PVA and water into a container for agitation at the ratio of 10 to 90 in volume in the listed order.

The mixed liquid was agitated by using agitation wings.

Through the above processes, the following raw solutions were generated: a raw solution agitated for 24 hours, a raw solution agitated for 36 hours, and a raw solution agitated for 48 hours.

Meanwhile, a raw solution for generating nanofibers was generated by using the fine polymer manufacturing apparatus 100 shown in FIG. 6 according to the method described below.

A liquid PVA (under a room temperature) was pumped, and discharged through a first discharge port 111.

Superheated steam (having a temperature of 300 degrees Celsius) was discharged through a second discharge port 121.

The liquid PVA and superheated steam were repeatedly discharged while the liquid collected in the storage tank 107 was being circulated.

Through the above processes, the following raw solutions were generated: a raw solution circulated for 10 minutes, a raw solution circulated for 20 minutes, and a raw solution circulated for 30 minutes.

These raw solutions were respectively used for generating nanofibers by using the fine polymer manufacturing apparatus 100. The combination of the raw material agitated for 48 hours and the raw solution circulated for 30 minutes circulated by using the fine polymer manufacturing apparatus 100 yields nanofibers containing excellent PVA. Experiment 1 showed that excellent nanofibers were generated by using superheated steam and a raw solution containing PVA generated in a short time.

### Experiment 2

### Using the Present Invention

Nylon and formic acid were prepared as a polymer and a solvent, respectively. A mixed liquid was generated by feeding Nylon and formic acid into a container for agitation at the ratio of 10 to 90 in volume in the listed order. The mixed liquid was agitated by using agitation wings.

Through the above processes, the following raw solutions were generated: a raw solution agitated for 24 hours, a raw solution agitated for 36 hours, and a raw solution agitated for 48 hours.

Meanwhile, a raw solution for generating nanofibers was generated by using the fine polymer manufacturing apparatus 100 shown in FIG. 6 according to the method described below.

A mixed liquid containing formic acid and Nylon crashed and dispersed in the formic acid was pumped and discharged through a first discharge port 111. Superheated steam (having a temperature of 300 degrees Celsius) was discharged through a second discharge port 121.

The mixed liquid and the superheated steam were repeatedly discharged while the liquid collected in the storage tank 107 was being circulated.

Through the above processes, the following raw solutions were generated: a raw solution circulated for 10 minutes, a raw solution circulated for 20 minutes, and a raw solution circulated for 30 minutes. The volume of each of the raw solutions is measured, and the measurement shows that the ratio of formic acid in the whole raw solution decreased approximately from 90 percent to 70 percent.

These raw solutions were respectively used for generating nanofibers by using the fine polymer manufacturing apparatus 100. The combination of the raw material agitated for 48 hours and the raw solution circulated for 30 minutes by using the fine polymer manufacturing apparatus 100 yields nanofibers containing excellent Nylon. Experiment 2 showed that excellent nanofibers were generated by mixing Nylon and formic acid to obtain a mixed liquid containing Nylon and formic acid, pumping the mixed liquid, discharging the mixed liquid and superheated steam. In addition to this, Experiment 2 showed that this method makes it is possible to drastically reduce the amount of solvent. Therefore, this method is effective in the case of using a resin requiring a large amount of expensive solvent. As described above, in the present invention, the polymer discharged from the first discharge port may also be in a form in which the polymer is dissolved in the organic solvent. In this case, water molecules from superheated steam mixes into the combined polymer and organic solvent, and thus enabling emulsification. As a result, by manufacturing nanofibers using the emulsified liquid, the amount of organic solvent to be used can be drastically reduced, the effect of which is extremely significant. In addition, stable raw solution can be generated in a short time, and thus the manufacturing process can also be shortened.

### INDUSTRIAL APPLICABILITY

The present invention is applicable for fields in which polymers having a low viscosity are necessary, and in particular is applicable for generating nanofibers and for manufacturing fiber spinning and nonwoven fabrics for which nanofibers are used.

1. A method for manufacturing a fine polymer, said method comprising:
generating superheated steam, said generating being performed by a superheated steam generating unit;
adjusting a pressure of the superheated steam generated in said generating, said adjusting being performed by a pressure adjusting unit;
receiving a polymer, said receiving being performed by a reception unit;
heating the polymer received in said receiving to a predetermined temperature, said heating being performed by a heating unit;
discharging the heated polymer having the predetermined temperature through a first discharge port; and
discharging the superheated steam through a second discharge port at a same time as a time when said discharging of the polymer is performed, the second discharge port surrounding the first discharge port, and the first discharge port and the second discharge port facing a same direction.

2. The method for manufacturing the fine polymer according to claim 1, said method further comprising:
re-supplying, to the reception unit, the fine polymer discharged in said discharging of the fine polymer.

3. A fine polymer manufacturing apparatus, comprising:
a superheated steam generating unit configured to generate superheated steam;
a pressure adjusting unit configured to adjust a pressure of the superheated steam generated by said superheated steam generating unit;
a reception unit for receiving a polymer;
a heating unit configured to heat the received polymer to a predetermined temperature;
a first discharge port through which the heated polymer is discharged; and
a second discharge port through which the superheated steam is discharged, said second discharge port surrounding said first discharge port, and said first discharge port and said second discharge port facing a same direction.

4. The fine polymer manufacturing apparatus according to claim 3, further comprising:
a conveying unit configured to convey, to said reception unit, the fine polymer discharged through said first discharge port.
